(19) United States
(12) Patent Application Publication
(10) Pub. No.: US 2011/0112751 A1
(43) Pub. Date: May 12, 2011

(54) NAVIGATION DEVICE AND METHOD OF DISPLAYING DATA

(76) Inventor: Harpreet Singh Sethi, Amsterdam (NL)

(21) Appl. No.: 12/736,931

(22) PCT Filed: Dec. 29, 2008
(86) PCT No.: PCT/EP2008/068326

§ 371 Date: Dec. 22, 2010

(51) Int. Cl. G01C 21/00; G06F 15/16

(52) U.S. Cl. 701/200; 709/219

(57) ABSTRACT

A system includes a processing device arranged to send and receive data to and from a network and including an output device and schedule request input; and a first server also arranged to send and receive data to and from a network. In at least one embodiment, the processing device is arranged to allow a user to select specified schedule information by use of the schedule request input for output on the device; and the processing device is further arranged, upon an input to the schedule request input to connect to the server across a network and obtain the specified schedule information therefrom and to output the schedule information on the output device.

### FIELD OF THE INVENTION

This invention relates to navigation devices and to methods for displaying data and in particular to displaying schedule information. Illustrative embodiments of the invention relate to portable navigation devices (so-called PNDs), in particular PNDs that include Global Positioning System (GPS) signal reception and processing functionality. Other embodiments relate, more generally, to any type of processing device that is configured to execute navigation software so as to provide route planning, and may be also navigation, functionality.

### BACKGROUND TO THE INVENTION

Portable navigation devices (PNDs) that include GPS (Global Positioning System) signal reception and processing functionality are well known and are widely employed as in-car or other vehicle navigation systems. Such PND's are a subset of Navigation devices in general and it is convenient to describe such PND's.

In general terms, a modern PNDs comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In some embodiments, the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favorite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads), or any other suitable criteria.

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

Users of such devices may need to make a journey, whether on foot, by car, or other transport to meet a scheduled event. The timing of such journeys can problematic for users since the length of a journey can be influenced by parameters such as traffic condition road closures, or the like. Further, the timing of such scheduled events may change. For example, there may be cancellations, delays and the like.

One example of such a scheduled event is a flight; either arriving or departing from an airport. The timing of such flights can often change due to delays inherent with air travel. As such, it is convenient for a user to be able to ascertain schedule information informing them of the current schedule information for such a scheduled event.

It can be possible to obtain some schedule information using, for example, an Internet browser, teletext, or the like. However, it can often be difficult to locate the correct schedule information using such approaches since a user needs to navigate through pages of information before finding the information that he/she requires. Further, such devices may not be portable with a user and as such should the schedule information change during the user's journey then he/she may not be aware of that change.

### SUMMARY OF THE INVENTION

According to a first aspect of the invention there is provided a system comprising:
a processing device arranged to send and receive data to and from a network and comprising an output device and schedule request input;
a first server also arranged to send and receive data to and from a network;
the processing device being arranged to allow a user to select specified schedule information by use of the schedule request input for output on the device; and
the processing device being further arranged, upon an input to the schedule request input to connect to the server across a network and obtain the specified schedule information therefrom and to output the schedule information on the output device.

Such a system may advantageously allow the processing device to obtain schedule information quicker and more conveniently than prior art systems. A user may simply need to activate the schedule request input and obtain the schedule information he/she requires from a single source without needing to search for the data, etc.

The processing device may conveniently be a navigation device and may in particular be a Portable Navigation Device (PND).

The first server may be arranged to receive schedule information. Such reception may upon instigation of the first server and/or may be on the instigation of a server remote from the first server.

For example, from time to time, the first server may be arranged to request schedule information from remote sources. Such requests may be on a periodic basis such as hourly, every few hours (for example every 2, 3, 4, 5, 6 or more hours), daily, or any other suitable period. Such embodiments, may place the first server in control of when the schedule information is obtained.

In other embodiments, in which the first server receives schedule information at the behest of the second server, schedule information may be received at other periods. A potential advantage of such embodiments, is that the second server may be arranged to send schedule information to the first server when the schedule information changes. As such, the schedule information held on the first server may be more accurate.

In other embodiments, the first server may be arranged to obtain schedule information when it receives a request for that data from a processing device. As such, the amount of storage required by the first server is likely to be reduced and the schedule information thereafter obtained by the first server may be more accurate.

The second server may be provided by a party proving a service to which the schedule information relates. For example, second server may be provided by an airport, an airline, etc.

The first server may be arranged to categorize the schedule information in a manner which makes it convenient for a processing device to obtain thereby increasing ease of use for a user.

In some embodiments, the first server is arranged to categorize the schedule information according to predetermined categories and may further be arranged to allow a processing device to browse data in such a predetermined category.

The predetermined categories may for example be any of the following: time of departure, time of arrival, departure place, arrival place, date of departure, carrier (eg airline, etc), delayed and/or cancelled events or the like.

In one particular embodiment the schedule information relates to flight data and in particular, the schedule information may relate to any of the following examples: time of flight departure, time of flight arrival, name of airport, departure gate, departure terminal, arrival terminal, airline, delayed flights, cancelled flights, date.

According to a second aspect of the invention there is provided a navigation device comprising:
a transmitter and a receiver arranged to respectively send and receive schedule information from a communication channel;
a schedule request input allowing a user thereof to make an input to the device requesting schedule information;
processing circuitry arranged to receive an input from the schedule request input and cause a request to be sent across the communication channel requesting the schedule information;
the processing circuitry being further arranged to receive schedule information from the receiver and to output the schedule information on an output device of the navigation device.

Such a navigation device comprising schedule request input may allow a user to obtain schedule information much more rapidly than in the prior art. This in turn may reduce network traffic.

The navigation device may be arranged to display the schedule information upon a display device.

Further, presentation of the schedule information on the navigation device may provide the schedule information to a user in a convenient manner saving him/her time and effort in obtaining the information.

The processing circuitry may be arranged to calculate a route dependent upon the schedule information. For example, the processing circuitry may be arranged to calculate a time of departure needed for a user to make a predetermined schedule event. Such route calculation may take into account the traffic flow, etc. that a user is likely to experience on his/her journey to the scheduled event.

According to a third aspect of the invention there is provided a method of sending schedule information to a processing device comprising:
providing the processing device with a schedule request input which upon activation causes the processing device to send a request to a remote first server;
causing the first server to collate schedule information from at least one, and generally a plurality of sources;
causing the first server to send the requested schedule information;
outputting the schedule information on an output device of the processing device.

Thus, the first server collates schedule information. Such collation may be in advance of the request for schedule information or may be in response to the request for schedule information.

Collation of the data in this manner may, not only provide a user with a service that is convenient, but may also facilitate a reduction in data being sent to the processing device and speed up the process of the user obtaining the data in which he/she is interested.

The schedule request input may be programmed with at least one, and generally a plurality of, predetermined selections that a user may make.

The method may allow a user of the processing device to browse categories of the schedule information and subsequently request further information, which may be more detailed, from the first server.

For example, in some embodiments, the method may allow a user to select a location, such as an airport, a train station, bus station or the like. Upon selection of the location the user may subsequently be able to select arrival or departure information. Upon selection, the user may subsequently be able to select a time, a time range, etc. Thus, a user may be able to select information of an increasing granularity upon selection. Such a method may prove especially convenient upon processing devices that have a limited display device capability and provide a mechanism for a user to select the data that he she requires.

According to a fourth aspect of the invention there is provided a machine readable medium containing instructions which when read onto a machine cause that machine to perform as either the first server and/or the processing device of the first aspect of the invention.

According to a fifth aspect of the invention there is provided a machine readable medium containing instructions which when read onto a machine cause that machine to perform as the navigation device according to a second aspect of the invention.

According to a sixth aspect of the invention there is provided a machine readable medium containing instructions which when read onto a machine cause that machine to perform the method of the third aspect of the invention.

In any of the above aspects of the invention the machine readable medium may comprise any of the following: a floppy disk, a CD ROM, a DVD ROM/RAM (including a −R/−RW and +R/+RW), a hard drive, a memory (including a USB memory key, an SD card, a Memorystick™, a compact flash card, or the like), a tape, any other form of magneto optical storage, a transmitted signal (including an Internet download, an FTP transfer, etc), a wire, or any other suitable medium.

### BRIEF DESCRIPTION OF THE DRAWINGS

Various aspects of the teachings of embodiments of the present invention, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIGS. 4A and 4B are illustrative perspective views of a navigation device;

FIG. 5 is a schematic representation of the software employed by the navigation device.

FIG. 6 shows a system according to one embodiment of the invention;

FIGS. 7A to 7E show schematic representations of screen displays from a device realising one embodiment of the present invention; and

FIG. 8 shows a flowchart of how the embodiment of FIG. 7 is used.

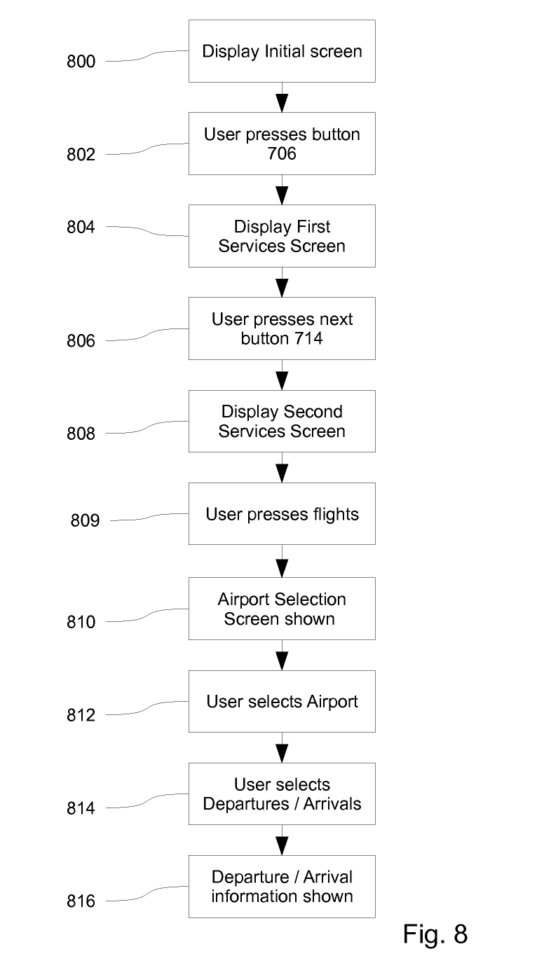

### DETAILED DESCRIPTION OF EMBODIMENTS OF THE PRESENT INVENTION

Embodiments of the present invention will now be described with particular reference to a Portable Navigation Device (PND). It should be remembered, however, that the teachings of the present invention are not limited to PNDs but are instead universally applicable to any type of processing device that will generally be configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or indeed a computing device (such as a desktop or portable personal computer (PC), mobile telephone or portable digital assistant (PDA)) which may execute route planning and navigation software.

It will also be apparent from the following that the teachings of the present invention even have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

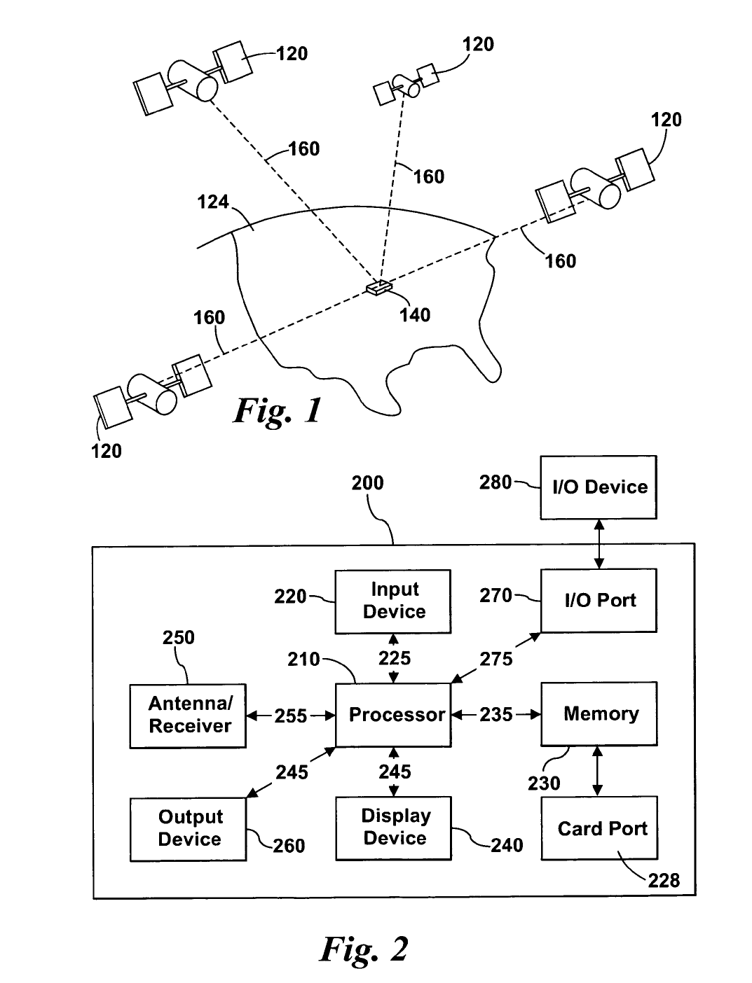

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in precise orbits. Based on these precise orbits, GPS satellites can relay their location to any number of receiving units. However, it will be understood that Global Positioning systems could be used, such as GLOSNASS, the European Galileo positioning system, COMPASS positioning system or IRNSS (Indian Regional Navigational Satellite System).

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize an accurate frequency standard accomplished with an accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

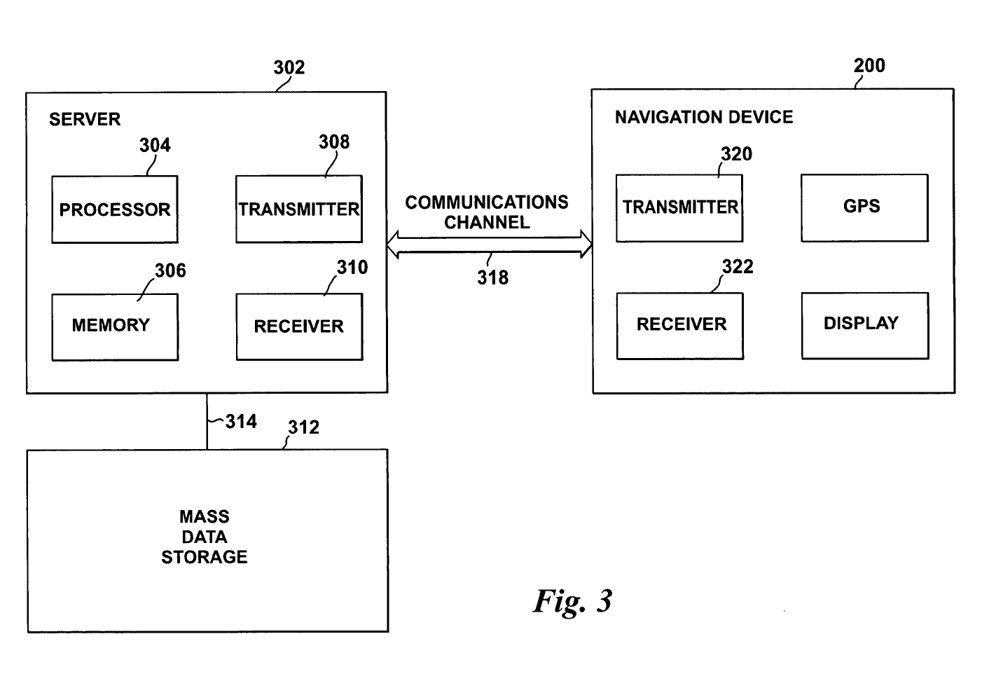

FIG. 2 is an illustrative representation of electronic components of a navigation device 200 according to an embodiment of the present invention, in block component format. It should be noted that the block diagram of the navigation device 200 is not inclusive of all components of the navigation device, but is only representative of many example components.

The navigation device 200 is located within a housing (not shown). The housing includes processing circuitry which in the embodiment being described s provided by a processor 210 connected to an input device 220 and a display screen 240, the display screen providing one example of an output device. The input device 220 can include a keyboard device, voice input device, touch panel and/or any other known input device utilised to input information; and the display screen 240 can include any type of display screen such as an LCD display, for example. In one embodiment the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include other examples of an output device such as an audible output device (e.g. a loudspeaker). As loudspeaker 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and loudspeaker 260, via output connections 245, to output information thereto. Further, the processor 210 is operably coupled to a memory resource 230 via connection 235 and is further adapted to receive/send information from/to input/output (I/O) ports 270 via connection 275, wherein the I/O port 270 is connectible to an I/O device 280 external to the navigation device 200. The memory resource 230 comprises, for example, a volatile memory, such as a Random Access Memory (RAM) and a non-volatile memory, for example a digital memory, such as a flash memory. The memory resource also comprises a port 228, which communicates with the processor 210 via connection 235, to allow a removable memory card (commonly referred to as a card) to be added to the device 200. In the embodiment being described the port is arranged to allow an SD (Secure Digital) card to be added. In other embodiments, the port may allow other formats of memory to be connected (such as Compact Flash (CF) cards, Memory Sticks™, xD memory cards, USB (Universal Serial Bus) Flash drives, MMC (MultiMedia) cards, SmartMedia cards, Microdrives, or the like).

The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

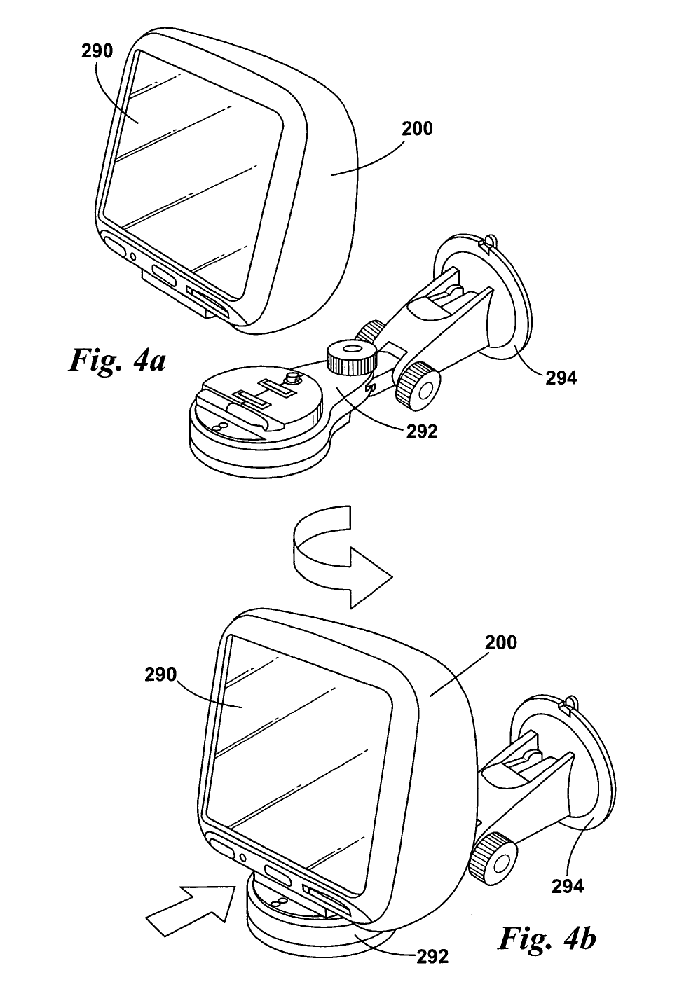

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS connection (General Packet Radio Service), a UMTS (Universal Mobile Telephone System)—or other 3G connection. (GPRS and UMTS connections provide a high-speed data connection for mobile devices provided by telecom operators; GPRS and UMTS each provide methods to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GRPS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

As described in more detail below, the server 306 also contains, or has access to, schedule information that can be accessed by the navigation device 200 across the communication channel 318.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be updated automatically from time to time, perhaps periodically, or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

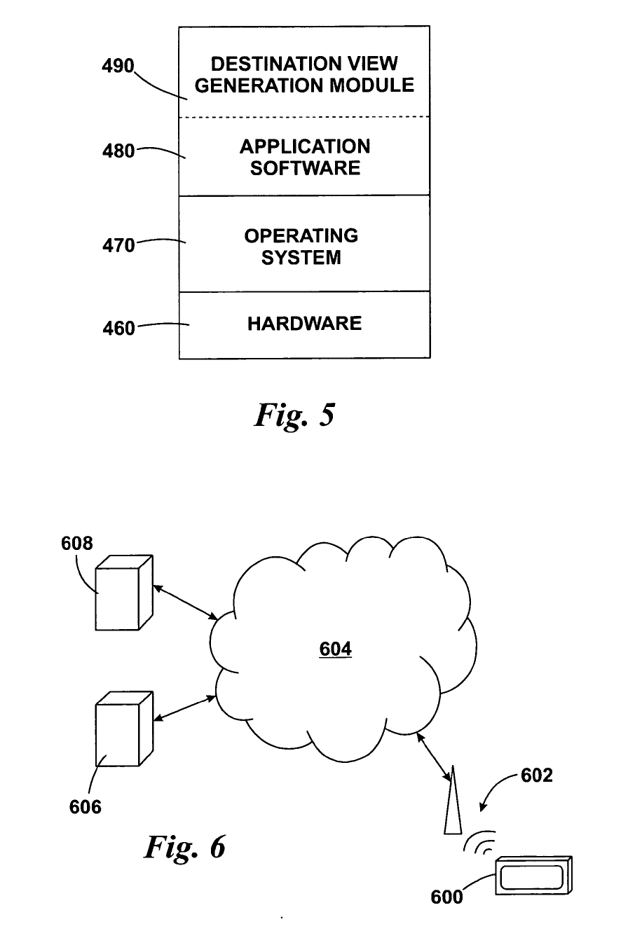

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

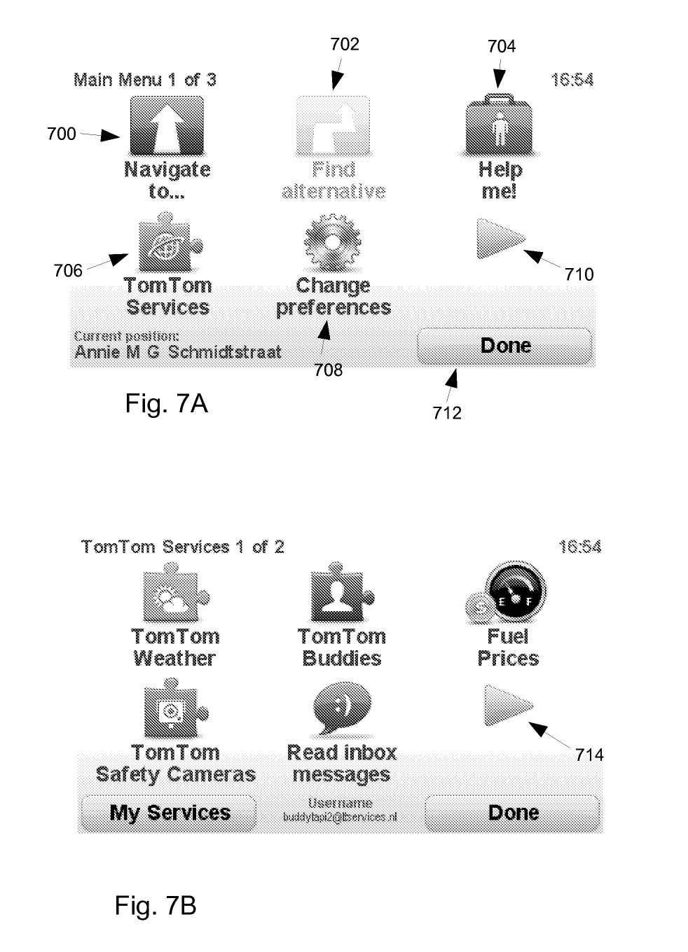

Referring now to FIG. 5 of the accompanying drawings, the memory resource 230 stores a boot loader program (not shown) that is executed by the processor 210 in order to load an operating system 470 from the memory resource 230 for execution by functional hardware components 460, which provides an environment in which application software 480 can run. The operating system 470 serves to control the functional hardware components 460 and resides between the application software 480 and the functional hardware components 460. The application software 480 provides an operational environment including the GUI that supports core functions of the navigation device 200, for example map viewing, route planning, navigation functions and any other functions associated therewith.

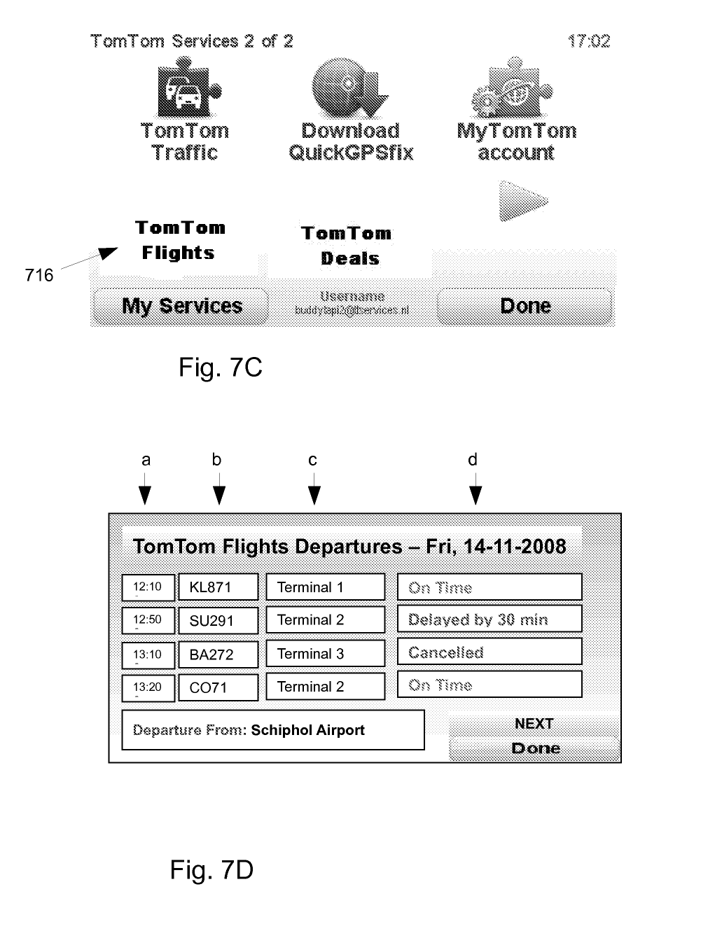

FIG. 6 shows a system according to one embodiment of the present invention. The embodiment comprises a PND 600 which is arranged to connect via a wireless network, such as a mobile telephone network 602, and a WAN (Wide Area Network), such as the Internet 604 to a first server 606. The skilled person will appreciate that the telephone network 602 and the WAN are providing the communication channel 318 which is described further in relation to FIG. 3. The PND 600 may be the PND described hereinbefore.

The first server 606 is arranged to communicate via a network, which may be a WAN, such as the Internet 604 with a second server 608. The second server 608 may or may not be remote from the first server 606 but will generally be situated remotely.

The skilled person will appreciate that whilst the first 606 and second 608 servers are represented and described as being single machines, they may in fact be provided by a plurality of different machines which may include or be virtual machines.

In the embodiment being described, the first server 606 is a server to which the user of the PND 600 has an account and it may for example be a server provided by a company that provides mapping data, etc. to the PND 600.

The second server 608 contains schedule information and may for example be a server provided by an airport, airline company, train station, train company, bus station, bus company or the like. However regardless of who provides the second server 608 the schedule information provides information regarding a service in which the user of the PND 600 may be interested.

The schedule information may comprise any of the following: arrival time, departure time, length of journey, destination, departure point (such as gate, platform, station, etc.), whether the transport is late, whether the transport is cancelled. The use of the phrase schedule is convenient should not be limited to timetable transport, nor even to transport. For example, it may be possible to obtain data about the location and expected arrival time of a taxi that has been ordered. Further, the schedule information may relate to the timing of a performance, such a cinema showing, a theatre show, a race or the like.

In the embodiment being described, the second server 608 is arranged, from time to time, to send predetermined scheduled data to the first server 606. There may be a plurality of second servers 608 each of which is arranged to send such predetermined schedule information to the first server 606. As such, the first server 606 contains a database of schedule information that a user of a PND may request. Such embodiments are perhaps convenient as they may allow retrieval of schedule information to a PND requesting the data quicker than other arrangements.

In other embodiments, the first server 606 may be arranged to request schedule information from a second server 608 when a request for schedule information is received from a PND 600. Such embodiments, may perhaps reduce overall network traffic and storage requirements on the first server 606. Any other suitable mechanism for allowing the first server 606 to access the schedule information may be provided.

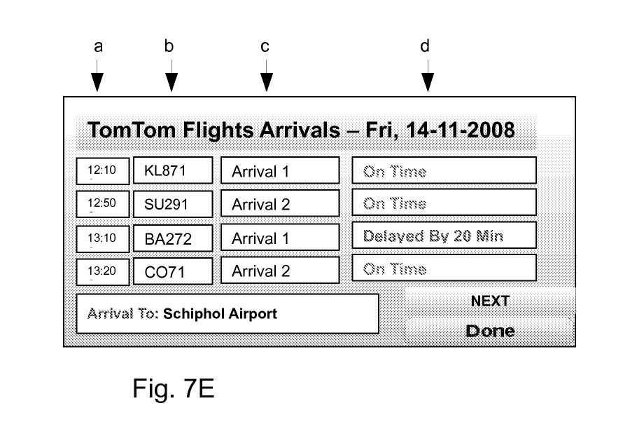

FIG. 7a shows a display (step 800) that the processor 210 causes the display device 240 to provide allowing a user of the PND 600 to make an input thereto. The display includes seven virtual buttons 700-712 that a user may press to cause an input to the processor 210.

In the example being given, a user presses the button 706 (step 802) which causes the processor 210 to display (step 804) the screen shown in FIG. 7b on the display device 240 which provides a first screen showing services that a user may select. In the example being given, a user presses the virtual button 714 (step 806) causing the processor 210 to display (step 808) a second screen of services as shown in FIG. 7c.

A user presses the virtual button 716, in step 809, which is labelled Tomtom™ Flights which causes the processor 210 to display on the display device 240, in step 810, a further screen allowing a user to select an airport for which he/she would like flight information. In this embodiment the Tomtom™ flights virtual button 716 provides a schedule request input which allows a user to retrieve schedule information as now described. Thus, the schedule request input is provided by the application software 480 and in the embodiment being described, this application software provides an operational environment including the GUI that supports core functions of the navigation device 200.

The Tomtom™ flight button 716 provides a user with a predetermined schedule selection that a user may activate thereby reducing the time it take him/her to locate information. In other embodiments further schedule request inputs may be provided on the PND 600. In yet further embodiments, the schedule request input may provide, upon activation, a user with a mechanism (such a list, input box or the like) with which the user may be able to select the type of schedule information that he/she requires. For example, a user may be presented with the following options: flight information; train information; performance information, or the like. Each of these may provide further selections once activated in order that the user is able to select more granular data.

Pressing the button 716 causes the PND 600 to communicate with the first server 606 and retrieve schedule information. Thus, at this point in the method being described the PND 600 retrieves a list of airports which are then displayed on the display device 240.

The user inputs, in step 712, the airport for which he/she would like further information, and in the example being given, the user inputs Amsterdam Schipol Airport. As with many user interfaces, a user may make an input via a number of different means. For example, a user may select an airport from a list presented on the display device 240, or may type the airport name into a text input box, or the like.

The processor 210 causes the display device 240 to display a further screen in which a user can select whether he/she wishes to view departure or arrival information. In the example being described, in step 814, a user selects that he/she wished to see the departure information and in step 816 the processor 210 retrieves schedule information from the first server 606 and subsequently, causes the display device 240 to display the screen shown in FIG. 7D.

The skilled person will appreciate that in the embodiment being described, the schedule information is obtained from the first server 606 upon an input being made to the schedule request input. Thus, data is delivered to a user quicker that would otherwise be the case and the user need only make an input to a the schedule request input rather than via several screens that would be required to access this information using a web browser or the like.

Should the user, in step 814, have selected to see the arrival information then the processor causes, in step 816, the display device to display the screen shown in FIG. 7E. However, the PND 60 is caused to access the first server 600 in a similar manner, mutatis mutandis, to the example described above in which a user requests departure information.

Each of the screens shown in FIGS. 7D and 7E has four columns A to D. Column A provides the time of the flight specified in a row of data. Column B specifies the flight number for that row. Column C specifies the terminal, gate or the like, from which the flight referred to in that row either departs from (FIG. 7D) or arrives at (FIG. 7E). Column Dd provides information as to the status of the flight referred to in that column. Such status information can include whether the flight is on time, delayed, early, cancelled, or the like.

As described above, the schedule information displayed in the columns A to D of FIGS. 7D and E is obtained via the communications channel 318 which connects the processor 210 to the first server 606.

1. A method of sending schedule information to a navigation device comprising: providing the navigation device with a schedule request input which upon activation causes the navigation device to send a request to a remote first server; causing the first server to collate schedule information from at least one, and generally a plurality of sources;
upon receipt of a request generated by use of a schedule request input on the navigation device causing the first server to send the requested schedule information; and
outputting the schedule information on an output device of the navigation device.

2. The method of claim 1 in which a user of the navigation device browses categories of the schedule information and subsequently requests further schedule information based upon data received as a result of his/her selection from the first server.

3. The method of claim 2 in which the further scheduled information is of increased granularity when compared to the earlier schedule information.

4. The method of claim 1 in which the navigation device calculates a route according to the schedule information.

5. The method of claim 4 in which the navigation device calculates a journey start time for the calculated route according to the schedule data.

6. A system comprising:
a navigation device arranged to send and receive data to and from a network and comprising an output device and schedule request input;
a first server also arranged to send and receive data to and from the network;
the navigation device being arranged to allow a user to select specified schedule information by use of the schedule request input for output on the device; and
the navigation device being further arranged, upon an input to the schedule request input to connect to the first server across the network and obtain the specified schedule information therefrom and to output the schedule information on the output device.

7. A system according to claim 6 in which the first server is arranged to receive schedule information and to store the schedule information within a memory accessible by the first server.

8. A system according to claim 6 in which the first server is arranged to obtain schedule information when it receives a request for that data from a navigation device.

9. A system according to claim 6 in which the first server is arranged to categorize the schedule information into predetermined categories.

10. A system according to claim 6 in which the schedule information relates to flight data and in particular, the schedule information may contain any of the following examples: time of flight departure, time of flight arrival, name of airport, departure gate, departure terminal, arrival terminal, airline, delayed flights, cancelled flights, date.

11. A navigation device comprising:
a transmitter and a receiver arranged to respectively send and receive schedule information to and from a communication channel;
a schedule request input allowing a user thereof to make an input to the device requesting schedule information;
processing circuitry arranged to receive an input from the schedule request input and cause a request to be sent across the communication channel requesting the schedule information;
the processing circuitry being further arranged to receive schedule information from the receiver and to output the schedule information on an output device of the navigation device.

12. The navigation device of claim 11 which is arranged to display the schedule information upon a display device.

13. The navigation device of claim 11 in which the processing circuitry is arranged to calculate a route dependent upon the schedule information.

14. The navigation device of claim 13 in which the processing circuitry is arranged to calculate a time of departure needed for a user to make a predetermined schedule event.

15. A non-transitory machine readable medium containing instructions which when read onto a machine cause that machine to perform
the method of claim 1.
